(19) United States
(12) Patent Application Publication
(10) Pub. No.: US 2014/0254802 A1
(43) Pub. Date: Sep. 11, 2014

(54) INFORMATION TERMINAL DEVICE, SOUND CONTROL METHOD AND PROGRAM

(71) Applicant: NEC CASIO Mobile Communications, Ltd., Kanagawa (JP)

(72) Inventor: Kenji FUKAZAWA, Saitama (JP)

(73) Assignee: NEC CASIO Mobile Communications, Ltd., Kanagawa (JP)

(21) Appl. No.: 14/196,731

(22) Filed: Mar. 4, 2014

(30) Foreign Application Priority Data
Mar. 5, 2013 (JP) 2013-043402

(51) Int. Cl. H04S 5/00

(52) U.S. Cl. CPC H04S 5/00
USPC 381/17

(57) ABSTRACT

An information terminal device, a sound control method and a program, which enable a good stereo surround effect suitable for a screen display to be obtained even with a miniature speaker. A controller (8) controls a selector (16) so as to switch the orientation of an image in a display unit (2) in accordance with the orientation of the information terminal device sensed by an orientation sensor (7), and, among at least 3 speakers (4, 5 and 6), a mid/high range stereo signal of a right channel is inputted to at least one speaker on the right side with respect to a user, a mid/high range stereo signal of a left channel is inputted to at least one speaker on the left side with respect to the user, and a low range monaural signal is inputted to another speaker.

### REFERENCE TO RELATED APPLICATION

This application is based upon and claims the benefit of the priority of Japanese patent application No. 2013-043402, filed on Mar. 5, 2013, the disclosure of which is incorporated herein in its entirety by reference thereto.

The present invention relates to an information terminal device having a plurality of speakers, a sound control method and a program.

### BACKGROUND

In recent years there has been an increase in the popularity of information terminal devices as represented by tablet terminals having a display unit of 5 inches or more and stereo speakers. In current information terminal devices, with regard to speaker output of voice, music and sound effects when playing video, music or games to accompany a screen display, for output sound from a speaker to the right side of a user, sound of a right side channel is outputted, and for output sound from a speaker to the left side of a user, sound of a left side channel is outputted, so that it is possible to obtain stereo and sound effects suitable for the screen display.

However, in a case where 2 speakers, for example, are mounted to the left and right below the display unit in the information terminal device, when the user holds the device after rotating it through 90 degrees there is a problem in that the 2 speakers are not arranged to the left and right of the user, but the 2 speakers are arranged on the right side or the left side of the user, and it is not possible to obtain good stereo surround effects suitable for the screen display.

A technology for solving this problem includes: an acceleration sensor sensing the direction of gravitational force; a sensor controller controlling the acceleration sensor and performing analysis of a sensing result of the acceleration sensor; a music path controller selecting, from a result of analyzing the sensing result of the acceleration sensor by the sensor controller, which of the 2 speakers outputs signals of a left channel and a right channel, that have been converted to analog signals; a ROM storing music data and a control program required for executing processing by a CPU; and a RAM having a region for deploying data and the control program required temporarily for executing processing by the CPU (see Patent Literature 1).

### PTL 1

JP Patent Kokai Publication No. JP2010-263559A

### SUMMARY

The entire disclosure of Patent Document 1 is incorporated herein by reference thereto.

The following analysis is given by the inventors of the present application.

In many cases, however, speakers mounted in information terminal devices are miniature speakers, and for a miniature speaker, since the maximum input capacity to the speaker has a low limit, if an input signal band is not limited, a signal of an adequate level cannot be inputted. That is, in the case of a miniature speaker, in order to avoid risks such as sound distortion due to excessive input and the increase of a speaker breakage risk, the sound volume has to be reduced and it has not been possible to obtain good stereo surround effects.

It is a principal object of the present disclosure to provide an information terminal device, a sound control method and a program, enabling good stereo surround effects to be obtained, suitable for a screen display even with a miniature speaker.

In a first aspect of the present disclosure, there is provided an information terminal device comprising: a display unit displaying an image; at least 3 speakers disposed at prescribed positions on a periphery of the display unit and outputting sound information; a first filter dividing a stereo signal of a left channel, among the sound information, into two signals: a low range stereo signal having a frequency less than a prescribed frequency and a mid/high range stereo signal having the prescribed frequency or more; a second filter dividing a stereo signal of a right channel, among the sound information, into two signals: a low range stereo signal having a frequency less than the prescribed frequency and a mid/high range stereo signal having the prescribed frequency or more; a mixer generating a low range monaural signal synthesizing the low range stereo signal of the left channel from the first filter and the low range stereo signal of the right channel from the second filter; a selector assigning the mid/high range stereo signal of the left channel from the first filter, the mid/high range stereo signal of the right channel from the second filter, and the low range monaural signal from the mixer, to the at least three speakers; an orientation sensor sensing orientation of the information terminal device held by a user; and a controller controlling the selector so as to switch orientation of the image in the display unit is switched and switch a signal inputted to the speakers, in accordance with the orientation of the information terminal device sensed by the orientation sensor; wherein the controller controls the selector so that, among the at least 3 speakers, the mid/high range stereo signal of the right channel is inputted to at least one speaker on the right side with respect to the user, the mid/high range stereo signal of the left channel is inputted to at least one speaker on the left side with respect to the user, and the low range monaural signal is inputted to another speaker.

In a second aspect of the present disclosure, there is provided a sound control method that controls sound using an information terminal device comprising: a display unit displaying an image; at least 3 speakers disposed at prescribed positions on a periphery of the display unit and outputting sound information; a first filter dividing a stereo signal of a left channel, among the sound information, into two signals: a low range stereo signal having a frequency less than a prescribed frequency and a mid/high range stereo signal having the prescribed frequency or more; a second filter dividing a stereo signal of a right channel, among the sound information, into two signals: a low range stereo signal having a frequency less than the prescribed frequency and a mid/high range stereo signal having the prescribed frequency or more; a mixer generating a low range monaural signal synthesizing the low range stereo signal of the left channel from the first filter and the low range stereo signal of the right channel from the second filter; a selector assigning the mid/high range stereo signal of the left channel from the first filter, the mid/high range stereo signal of the right channel from the second filter, and the low range monaural signal from the mixer, to the at least three speakers; an orientation sensor sensing orientation of the information terminal device held by a user; and a controller controlling the display unit and the selector; wherein the method comprises controlling the selector, by the controller, so that orientation of the image in the display unit is switched in accordance with the orientation of the information terminal device sensed by the orientation sensor, and also, among the at least 3 speakers, the mid/high range stereo signal of the right channel is inputted to at least one speaker on the right side with respect to the user, the mid/high range stereo signal of the left channel is inputted to at least one speaker on the left side with respect to the user, and the low range monaural signal is inputted to another speaker.

In a third aspect of the present disclosure, there is provided a program controlling sound using an information terminal device comprising: a display unit displaying an image; at least 3 speakers disposed at prescribed positions on a periphery of the display unit and outputting sound information; a first filter dividing a stereo signal of a left channel, among the sound information, into two signals: a low range stereo signal having a frequency less than a prescribed frequency and a mid/high range stereo signal having the prescribed frequency or more; a second filter dividing a stereo signal of a right channel, among the sound information, into two signals: a low range stereo signal having a frequency less than the prescribed frequency and a mid/high range stereo signal having the prescribed frequency or more; a mixer generating a low range monaural signal synthesizing the low range stereo signal of the left channel from the first filter and the low range stereo signal of the right channel from the second filter; a selector assigning the mid/high range stereo signal of the left channel from the first filter, the mid/high range stereo signal of the right channel from the second filter, and the low range monaural signal from the mixer, to the at least three speakers; an orientation sensor sensing orientation of the information terminal device held by a user; and a controller controlling the display unit and the selector; wherein the program executes control of the selector, by the controller, so that orientation of the image in the display unit is switched in accordance with the orientation of the information terminal device sensed by the orientation sensor, and also, among the at least 3 speakers, the mid/high range stereo signal of the right channel is inputted to at least one speaker on the right side with respect to the user, the mid/high range stereo signal of the left channel is inputted to at least one speaker on the left side with respect to the user, and the low range monaural signal is inputted to another speaker. The program may be stored by a non transient storage medium.

According to the disclosure it is possible to obtain good stereo surround effects with a rich low-tone range, in accordance with user direction.

### BRIEF DESCRIPTION OF THE DRAWINGS

FIG. 1 is an outline view schematically showing a configuration of an external view of an information terminal device according to a first exemplary embodiment of the present disclosure.

FIG. 2 is a block diagram schematically showing a circuit configuration of the information terminal device according to the first exemplary embodiment of the disclosure.

FIG. 3 is a diagram showing states A to D when the orientation of a device is changed with respect to the direction of gravitational force when viewing a video or the like with the information terminal device according to the first exemplary embodiment of the disclosure.

FIG. 4 is a table showing correspondence relationships between the states A to D of FIG. 3 and output settings of respective speakers when the orientation of a device is changed with respect to the direction of gravitational force when viewing a video or the like with the information terminal device according to the first exemplary embodiment of the disclosure.

FIG. 5 is a flowchart schematically showing operations when the orientation of a device is changed with respect to the direction of gravitational force when viewing a video or the like with the information terminal device according to the first exemplary embodiment of the disclosure.

FIG. 6 is a block diagram schematically showing circuit state for speaker output settings of state D when the orientation of a device is changed with respect to the direction of gravitational force when viewing a video or the like with the information terminal device according to the first exemplary embodiment of the disclosure.

FIG. 7 is a diagram showing frequency characteristics of a general dynamic speaker.

FIG. 8 is a block diagram schematically showing a circuit configuration of an information terminal device according to a second exemplary embodiment of the present disclosure.

FIG. 9 is a table showing speaker output settings with regard to sound volume settings in state A when the orientation of a device is changed with respect to the direction of gravitational force when viewing a video or the like with the information terminal device according to the second exemplary embodiment of the disclosure.

FIG. 10 is a diagram showing low range and mid/wide range output sound pressure for a speaker with regard to sound volume settings in state A when the orientation of a device is changed with respect to the direction of gravitational force when viewing a video or the like with the information terminal device according to the second exemplary embodiment of the disclosure.

FIG. 11 is a table showing speaker output settings with regard to sound volume settings in state A when the orientation of a device is changed with respect to the direction of gravitational force when viewing a video or the like with the information terminal device according to a third exemplary embodiment of the disclosure.

FIG. 12 is an outline view schematically showing the configuration of an external view of the information terminal device according to a fourth exemplary embodiment of the disclosure.

FIG. 13 is a block diagram schematically showing a circuit configuration of the information terminal device according to the fourth exemplary embodiment of the disclosure.

FIG. 14 is an outline view schematically showing the configuration of an external view of the information terminal device according to a fifth exemplary embodiment of the disclosure.

FIG. 15 is an outline view schematically showing the configuration of an external view of the information terminal device according to a sixth exemplary embodiment of the disclosure.

FIG. 16 is an outline view schematically showing the configuration of an external view of the information terminal device according to a seventh exemplary embodiment of the disclosure.

### PREFERRED MODES

### First Exemplary Embodiment

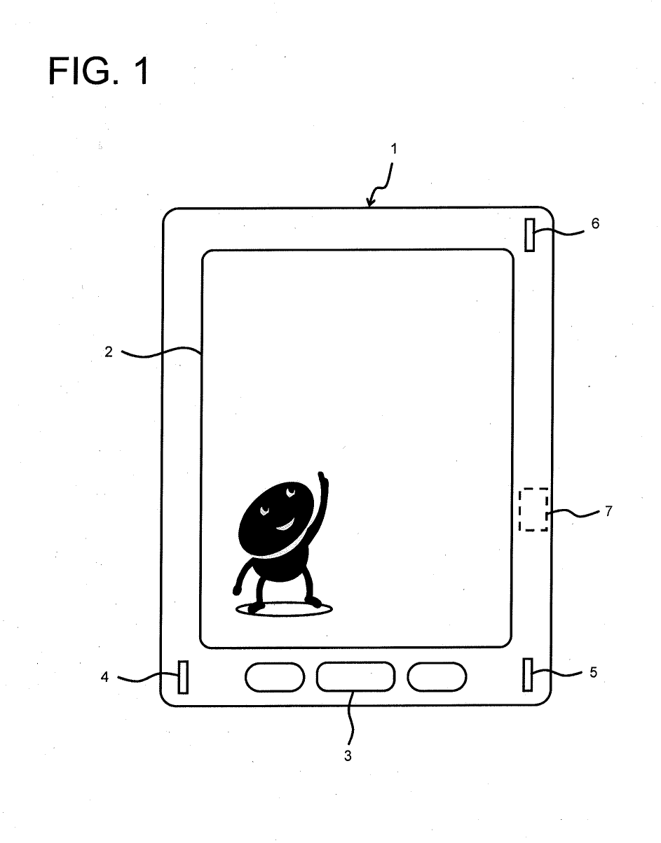

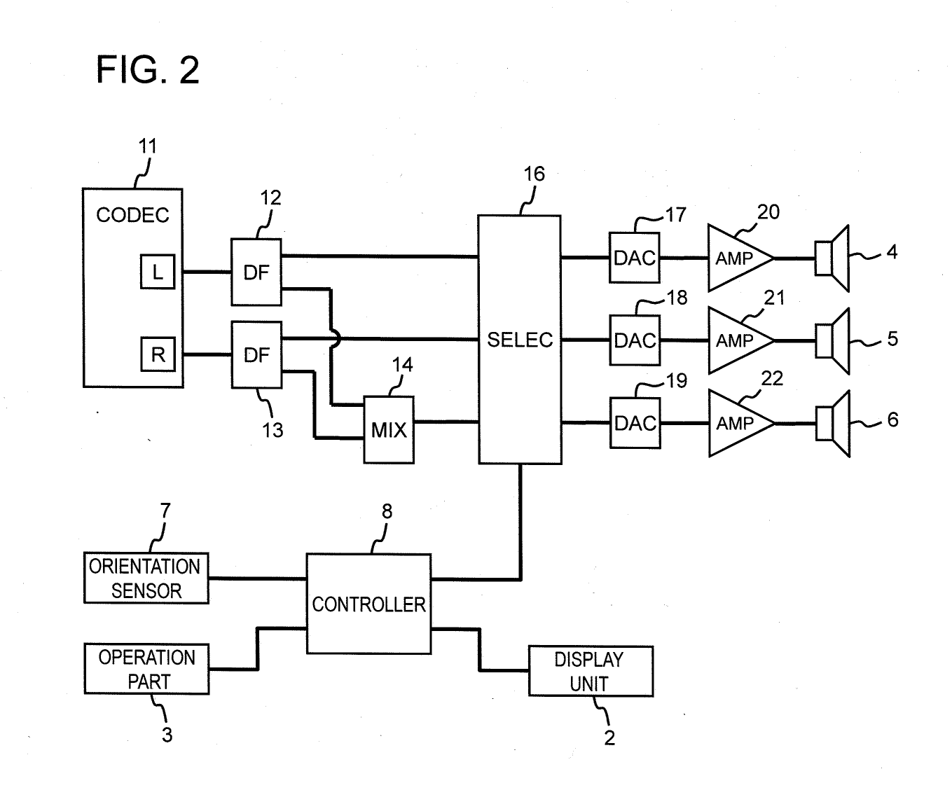

A description is given using the drawings concerning an information terminal device according to a first exemplary embodiment of the present disclosure. FIG. 1 is an outline view schematically showing the configuration of an external view of the information terminal device according to the first exemplary embodiment of the disclosure. FIG. 2 is a block diagram schematically showing a circuit configuration of the information terminal device according to the first exemplary embodiment of the disclosure.

Referring to FIG. 1, the information terminal device 1 is a device that displays images such as a video or still images, and outputs sound information such as voice, music or the like. The information terminal device 1, for example, may be a tablet terminal, a mobile telephone, a transceiver, a portable DVD player, a portable TV, a portable audio device or the like. The information terminal device 1 has a thin tabular form of rectangular shape. The information terminal device 1 has a function whereby screen direction and output position of sound information are changed in accordance with change of orientation (bearing, direction, inclination) of the device with respect to the direction of gravitational force. The information terminal device 1 has a function to output sound information having a stereo surround effect, and a function to separate and output sound information of a low range of less than a prescribed frequency, and sound information of mid/high range of the prescribed frequency or more. The information terminal device 1 may have 3D using center woofer, 2.1 ch, or a subwoofer system. The information terminal device 1 includes: a display unit 2, an operation part 3, speakers 4, 5, 6, an orientation sensor 7, a controller 8, a codec 11 (CODEC), digital filters 12 and 13 (DF), a mixer 14 (MIX), a selector 16, D/A converters 17, 18, 19, and speaker amplifiers 20, 21, 22 (see FIG. 1 and FIG. 2).

The display unit 2 is a functional unit displaying video, still images, operation screens, Web screens, photograph screens and the like (see FIG. 1 and FIG. 2). The display unit 2, for example, may be disposed so as to be seen from a window on a face on one side (both faces are also possible) of a casing of the information terminal device 1. For the display unit 2, for example, a Liquid Crystal Display (LCD), an organic electroluminescence display, or the like may be used. The display unit 2 may have a touch panel as a portion of the operation part 3. For the display unit 2, content and direction of the screen are controlled by the controller 8.

The operation part 3 is a functional unit to input operations of a user of the information terminal device 1 (see FIG. 1 and FIG. 2). The operation part 3, for example, may use a switch button arranged in an area below the display unit 2 on a face on one side of the casing of the information terminal device 1, or a touch panel arranged on the surface of the display unit 2. Information related to operations by the operation part 3 is outputted to the controller 8.

The speakers 4, 5, and 6 are functional units that output sound information such as voice, music and the like (see FIG. 1 and FIG. 2). There are at least three of the speakers 4, 5, and 6 in the information terminal device 1 (three in FIG. 1 and FIG. 2). The speaker 4, for example, may be disposed inside a sound output hole in an area on the left side of the operation part 3 below the display unit 2 on a face on one side of the casing of the information terminal device 1 as shown in FIG. 1. The speaker 5, for example, may be mounted inside a sound output hole in an area on the right side of the operation part 3 below the display unit 2 on a face on one side of the casing of the information terminal device 1 as shown in FIG. 1. The speaker 6, for example, may be mounted inside a sound output hole in an area on the right side (the left side is also possible) of the display unit 2 on a face on one side of the casing of the information terminal device 1 as shown in FIG. 1.

The orientation sensor 7 is a functional unit that senses orientation (bearing, direction, inclination) of the information terminal device 1 that is being held by the user (see FIG. 1 and FIG. 2). A geomagnetic sensor, a gravity sensor, an acceleration sensor or the like may be used, for example, in the orientation sensor 7. The orientation sensor 7 may be mounted inside the information terminal device 1. The orientation sensor 7 outputs a signal related to the orientation of the information terminal device 1, which has been sensed, to the controller 8.

The controller 8 is a functional unit having a computer function that performs information processing and control by execution of a prescribed program (see FIG. 2). The controller 8 switches orientation of the screen of the display unit 2, and at the same time switches signals received by respective speakers 4, 5 and 6, by controlling a selector 16, based on a signal related to the orientation of the information terminal device 1 as sensed by the orientation sensor 7.

The controller 8, by control of the selector 16, selects (assigns) respective signals of a right channel, a left channel and woofer according to the orientation of the screen of the display unit 2, outputs from a suitable speaker, and performs control to give input of a mid/high range stereo signal of the left channel from the left side speaker (speaker 4 in FIG. 1), a mid/high range stereo signal of the right channel from the right side speaker (speaker 5 in FIG. 1), and a low range monaural signal as a woofer from the other speaker (speaker 6 in FIG. 1), to the user of the information terminal device 1. That is, the controller 8, by the control of the selector 16, determines the speakers 4, 5 and 6, that are input destinations of received signals so as to realize 3D and stereo for the user of the information terminal device 1.

The codec 11 (CODEC; COder/DECoder) is an electronic circuit (an IC or software is also possible) that can both encode and decode data according to a fixed rule (see FIG. 2). The codec 11 decodes a signal (a signal in an encoded state) related to sound information of voice, music or the like, from a sound source such as a wireless circuit, inbuilt memory, external memory or the like, not shown in the drawings, and generates a stereo digital signal (stereo signal). The codec 11 outputs, among generated stereo signals, a stereo signal of a left channel (L) to a digital filter 12, and outputs a stereo signal of a right channel (R) to a digital filter 13.

The digital filters 12 and 13 (DF) are electronic circuits (software is also possible) that divide an input signal into two bands of: a low range where frequency is less than a prescribed value, and a mid/high range where frequency is the prescribed value or more. The digital filter 12 receives a stereo signal of the left channel (L) from the codec 11, divides the stereo signal received from the left channel (L) into two bands, low range and mid/high range, outputs the divided mid/high range stereo signal of the left channel (L) to the selector 16, and outputs the divided low range stereo signal of the left channel (L) to the mixer 14. The digital filter 13 receives a stereo signal of the right channel (R) from the codec 11, divides the stereo signal received from the right channel (R) into two bands, low range and mid/high range, outputs the divided mid/high range stereo signal of the right channel (R) to the selector 16, and outputs the divided low range stereo signal of the right channel (R) to the mixer 14.

The mixer 14 (MIX) is an electronic circuit (software is also possible) that generates a low range monaural signal synthesizing a low range stereo signal of the left channel (L) and a low range stereo signal of the right channel (R) (see FIG. 2). The mixer 14 receives the low range stereo signal of the left channel (L) from the digital filter 12 and the low range stereo signal of the right channel (R) from the digital filter 13, generates a low range monaural signal (here, a monaural digital signal) synthesizing the two received low range stereo signals, and outputs the generated low range monaural signal to the selector 16.

The selector 16 (SELEC) is an electronic circuit (software is also possible) that assigns respective inputted signals (mid/high range stereo signal of the left channel (L), mid/high range stereo signal of the right channel (R), low range monaural signal) to prescribed speakers 4, 5 and 6, according to control by the controller 8 (see FIG. 2). The selector 16 receives the mid/high range stereo signal of the left channel (L) from the digital filter 12, the mid/high range stereo signal of the right channel (R) from the digital filter 13, and the low range monaural signal from the mixer 14 (here, a monaural digital signal), assigns the respective received signals, according to control by the controller 8, to D/A converters 17, 18 and 19, corresponding to the prescribed speakers 4, 5 and 6, and outputs the respective assigned signals to the corresponding D/A converters 17, 18 and 19.

The D/A converters 17, 18 and 19 (DAC) are electronic circuits (software is also possible) that convert the digital signals from the selector 16 to analog signals, and output to the corresponding speaker amplifiers 20, 21 and 22 (see FIG. 2).

The speaker amplifiers 20, 21 and 22 (AMP) are electronic circuits (software is also possible) that amplify analog signals from the D/A converters 17, 18 and 19, and output to the corresponding speakers 4, 5 and 6 (see FIG. 2).

It is to be noted that in the information terminal device 1 according to the first exemplary embodiment, a battery, an antenna, a wireless circuit, an inbuilt memory, an external memory, a drive circuit of the display unit 2, and the like are omitted (not shown in the drawings).

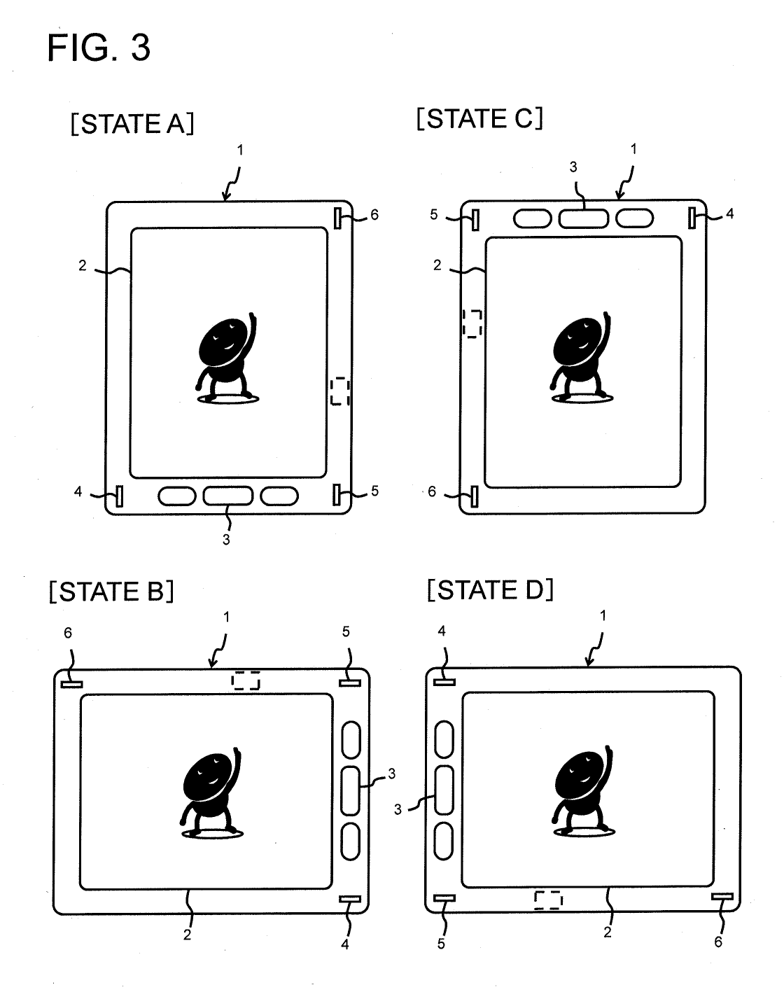

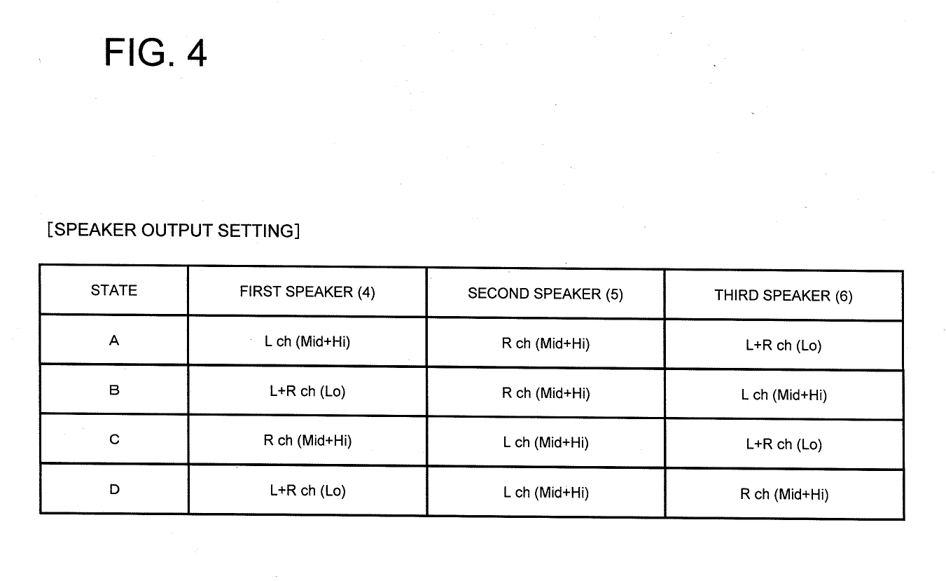

A description is given of operation of the information terminal device according to the first exemplary embodiment of the disclosure, using the drawings. FIG. 3 is a diagram showing states A to D when the orientation of a device is changed with respect to the direction of gravitational force when viewing a video or the like with the information terminal device according to the first exemplary embodiment of the disclosure. FIG. 4 is a table showing correspondence relationships between the states A to D of FIG. 3 and output settings of respective speakers when the orientation of the device is changed with respect to the direction of gravitational force when viewing a video or the like with the information terminal device according to the first exemplary embodiment of the disclosure.

When a video is viewed by the information terminal device 1, if the device orientation is changed, the information terminal device 1 senses the orientation of the device with respect to the direction of gravitational force by the orientation sensor 7, calculates the orientation of the screen with respect to the user, in the controller 8, changes the orientation of the screen of the display unit 2 based on the calculated orientation of the screen, and assigns the input signals to the respective speakers 4, 5 and 6 by controlling the selector 16 in correspondence with the calculated orientation of the screen, as in FIG. 3 and FIG. 4.

State A of FIG. 3 is a case where the user is holding the information terminal device 1 with the operation part 3 to the bottom. In state A, an image displayed in the display unit 2 is displayed with the operation part 3 to the bottom. In state A, with regard to sound outputted from the respective speakers 4, 5 and 6, as shown in FIG. 4, a mid/high range stereo signal (L ch (Mid+Hi)) of the left channel is outputted from the first speaker 4, a mid/high range stereo signal (R ch (Mid+Hi)) of the right channel is outputted from the second speaker 5, and a low range monaural signal (L+R ch (Lo)) synthesizing low range stereo signals of the left channel and the right channel is outputted from the third speaker 6.

State B of FIG. 3 is a case where the user is holding the information terminal device 1 with the operation part 3 to the right, and the first speaker 4 to the bottom. In state B, an image displayed in the display unit 2 is displayed with the first speaker 4 side to the bottom. In state B, with regard to sound outputted from the respective speakers 4, 5 and 6, as shown in FIG. 4, a low range monaural signal (L+R ch (Lo)) synthesizing low range stereo signals of the left channel and the right channel is outputted from the first speaker 4, a mid/high range stereo signal (R ch (Mid+Hi)) of the right channel is outputted from the second speaker 5, and a mid/high range stereo signal (L ch (Mid+Hi)) of the left channel is outputted from the third speaker 6.

State C of FIG. 3 is a case where the user is holding the information terminal device 1 with the operation part 3 to the top. In state C, an image displayed in the display unit 2 is displayed with the operation part 3 to the top. In state C, with regard to sound outputted from the respective speakers 4, 5 and 6, as shown in FIG. 4, a mid/high range stereo signal (R ch (Mid+Hi)) of the right channel is outputted from the first speaker 4, a mid/high range stereo signal (L ch (Mid+Hi)) of the left channel is outputted from the second speaker 5, and a low range monaural signal (L+R ch (Lo)) synthesizing low range stereo signals of the left channel and the right channel is outputted from the third speaker 6.

State D of FIG. 3 is a case where the user is holding the information terminal device 1 with the operation part 3 to the left with respect to the user and the first speaker 4 to the top. In state D, an image displayed in the display unit 2 is displayed with the first speaker 4 side to the top. In state D, with regard to sound outputted from the respective speakers 4, 5 and 6, as shown in FIG. 4, a low range monaural signal (L+R ch (Lo)) synthesizing low range stereo signals of the left channel and the right channel is outputted from the first speaker 4, a mid/high range stereo signal (L ch (Mid+Hi)) of the left channel is outputted from the second speaker 5, and a mid/high range stereo signal (R ch (Mid+Hi)) of the right channel is outputted from the third speaker 6.

As described above, by switching the orientation of the screen display according to the state (bearing, direction, inclination) of the information terminal device 1 and assigning the respective signals related to sound information matching the screen orientation to the respective speaker 4, 5 and 6, to be outputted, the user can view a video or the like with good stereo surround output that matches the screen.

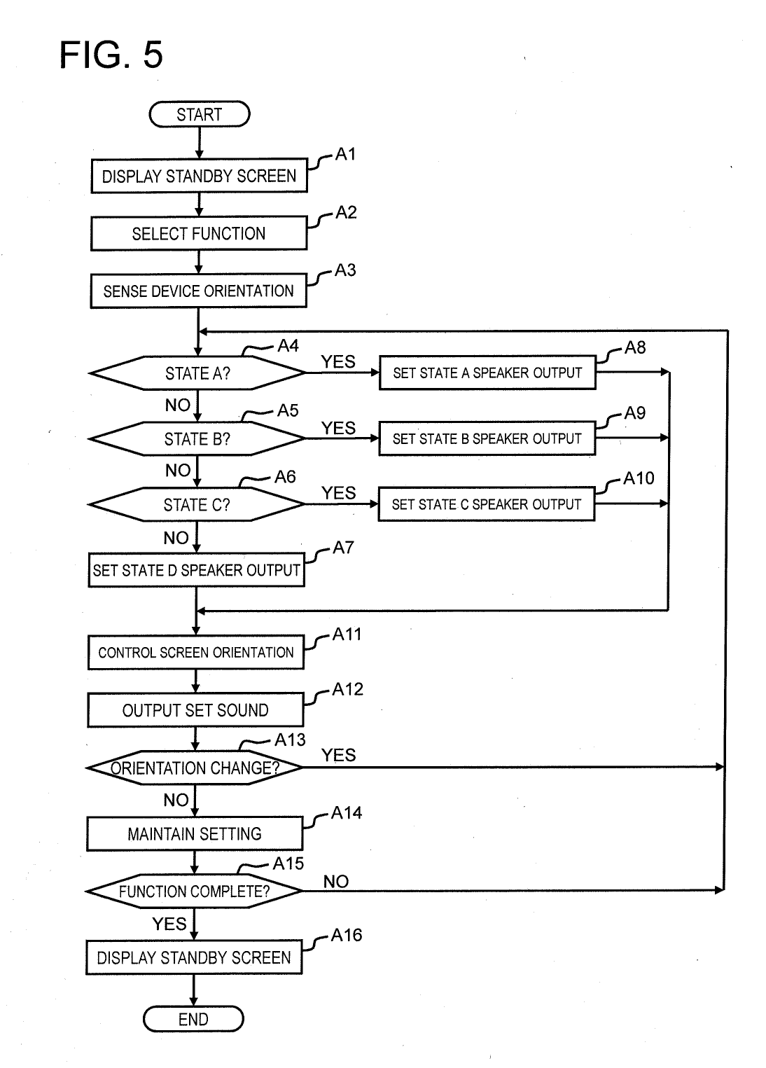

Next, a description is given using the drawings concerning operations of switching orientation of the screen and operations when switching output settings of the respective speakers, when the orientation of the device is changed with respect to the direction of gravitational force when viewing a video or the like with the information terminal device according to the first exemplary embodiment of the disclosure. FIG. 5 is a flowchart schematically showing operations when the orientation of the device is changed with respect to the direction of gravitational force when viewing a video or the like with the information terminal device according to the first exemplary embodiment of the disclosure.

First the information terminal device 1, through an operation of the operation part 3 by the user, displays a standby screen (displays a function (icon) selection screen) in the display unit 2 (step A1); thereafter, when a selection is made, in the function selection screen within the standby screen displayed in the display unit 2, of a function (for example, a video replay function, a music replay function, a game, etc.) to accompany output of image and sound information (step A2), orientation (direction with respect to the direction of gravitational force) sensing for the device by the orientation sensor 7 is started, and a signal related to the sensed orientation is outputted to the controller 8 from the orientation sensor 7 (step A3).

Next, when the signal related to the orientation is received by the controller 8, the information terminal device 1 determines, in the controller 8, whether the orientation of the device is in state A (see FIG. 3) (step A4). In a case where the determination is that the orientation is in state A (YES in step A4), control proceeds to step A8.

In a case where the determination is that the orientation is not in state A (NO in step A4), the information terminal device 1 determines, in the controller 8, whether the orientation of the device is in state B (see FIG. 3) (step A5). In a case of the orientation being in state B (YES in step A5), control proceeds to step A9.

In a case where the determination is that the orientation is not in state B (NO in step A5), the information terminal device 1 determines, in the controller 8, whether the orientation of the device is in state C (see FIG. 3) (step A6). In a case of the orientation being in state C (YES in step A6), control proceeds to step A10.

In a case where the determination is that the orientation is not in state C (NO in step A6), the information terminal device 1 determines, in the controller 8, that the orientation of the device is in state D, selects a speaker output setting (see FIG. 4) corresponding to the determined state D (step A7), and thereafter control proceeds to step A11.

In a case of the orientation being in state A (YES in step A4), the information terminal device 1 selects, in the controller 8, a speaker output setting (see FIG. 4) corresponding to the determined state A (step A8), and thereafter control proceeds to step A11.

In a case where the determination is that the orientation is in state B (YES in step A5), the information terminal device 1 selects, in the controller 8, a speaker output setting (see FIG. 4) corresponding to the determined state B (step A9), and thereafter control proceeds to step A11.

In a case where the determination is that the orientation is in state C (YES in step A6), the information terminal device 1 selects, in the controller 8, a speaker output setting (see FIG. 4) corresponding to the determined state C (step A10), and thereafter control proceeds to step A11.

After any one of steps A7, A8, A9 or A10, the information terminal device 1, by control of the controller 8, controls the direction of the screen displayed in the display unit 2 (see FIG. 3) in accordance with the determined device orientation (any one of states A, B, C or D) of the device (step A11).

Next, by controlling the selector 16 based on the selected speaker output settings (FIG. 4), in the controller 8, the information terminal device 1 outputs sound in accordance with the selected speaker output settings (FIG. 4) from the respective speakers 4, 5 and 6.

In step A12, sound outputted from the respective speakers 4, 5 and 6, in state A (see FIG. 4) for example, is assigned by the selector 16, through control of the controller 8, such that a mid/high range stereo signal (L ch (Mid+Hi)) of the left channel is outputted from the first speaker 4, a mid/high range stereo signal (R ch (Mid+Hi)) of the right channel is outputted from the second speaker 5, and a low range monaural signal (L+R ch (Lo)) synthesizing low range stereo signals of the left channel and the right channel from the third speaker 6, and sound information is outputted. The same applies also with regard to other orientations (states B, C and D) of the device.

After step A12, the information terminal device 1 periodically monitors signals related to the orientation of the device as sensed by the orientation sensor 7, in the controller 8, and determines whether there is a change in the orientation of the device (step A13). In a case where there is a change in the orientation of the device (YES in step A13), control proceeds to step A4, and a change is made to the direction of the screen and the speaker output settings to match the orientation of the device.

In a case where there is no change in the orientation of the device (NO in step A13), the information terminal device 1 maintains the direction of the screen and the speaker output settings.

After step A14, the information terminal device 1, by an operation of the operation part 3 by the user, determines by the controller 8, whether there has been an operation that completes a function selected in step A2 (step A15). In a case of there being no operation to complete the function (NO in step A15), control proceeds to step A4, to perform a change or to maintain the direction of the screen and the speaker output settings to match the orientation of the device.

In a case of there being an operation to complete the function (YES in step A15), the information terminal device 1 displays a standby screen (displays a function (icon) selection screen) in the display unit 2 (step A16), and thereafter finishes.

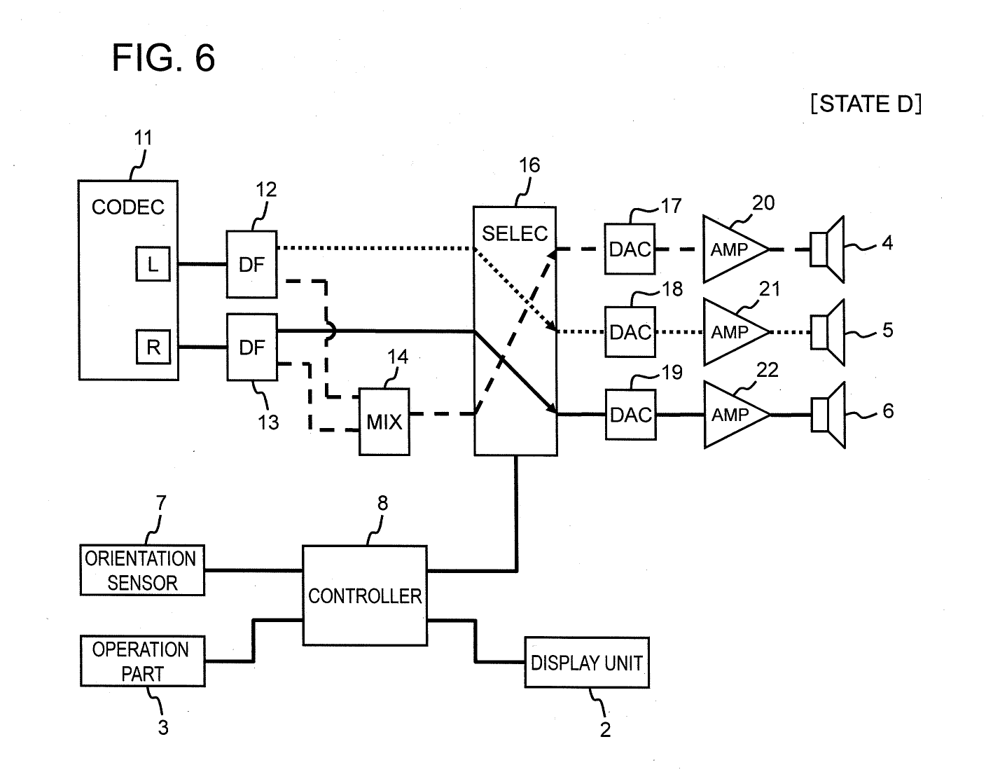

Next, a description is given using the drawings concerning operations of respective component parts when the orientation of the device is in state D when viewing a video with the information terminal device 1 as described in FIG. 3 to FIG. 5. FIG. 6 is a block diagram schematically showing a circuit state for speaker output settings of state D when the orientation of the device is changed with respect to the direction of gravitational force when viewing a video or the like with the information terminal device according to the first exemplary embodiment of the disclosure.

On selection of a function outputting sound information accompanying a screen display such as a video replay or a game in step A2 of FIG. 5, image data and voice or music signals from a wireless circuit, built-in memory or external memory, not shown in the drawings, are received or read, and the image data is displayed in the display unit 2. Meanwhile, a sound information stereo signal is decoded as a digital signal in the codec 11, the respective left (L) channel and right (R) channel stereo signals are divided into low range stereo signal (Lo) and mid/high range stereo signal (Mid+Hi) bands in the digital filters 12 and 13 to generate a monaural signal (L+R_Lo) synthesizing a low range stereo signal (L_Lo) of the left channel and a low range stereo signal (R_Lo) of the right channel in the mixer 14. In this way, the three generated signals of a mid/high range stereo signal (L_Mid+Hi) of the left channel, a mid/high range stereo signal (R_Mid+Hi) of the right channel, and the a low range monaural signal (L+R_Lo) are outputted to the selector 16.

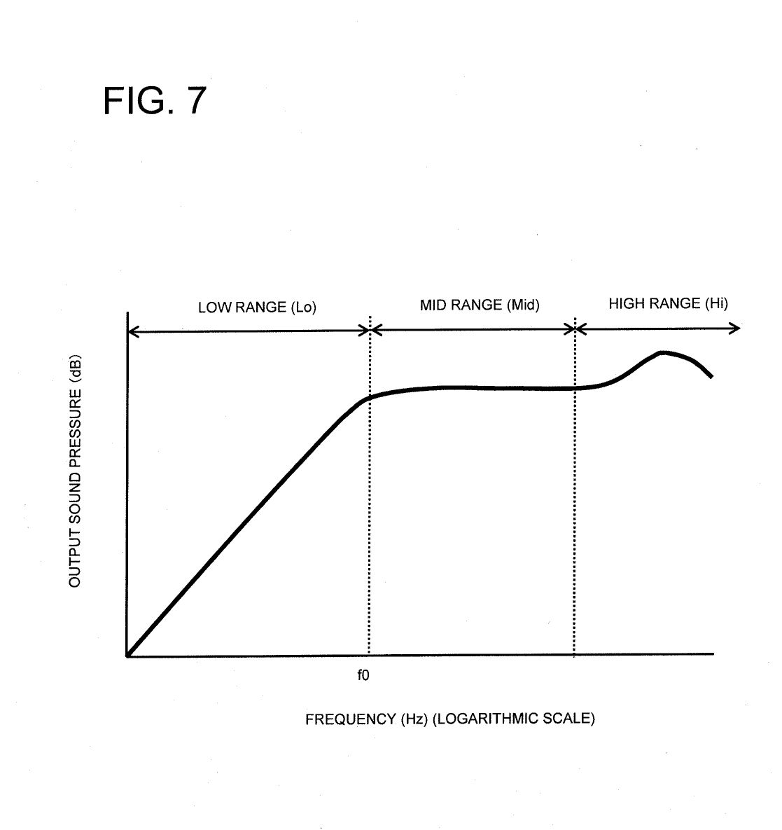

Here, a description is given using FIG. 7 concerning band division of the stereo signals. FIG. 7 is a diagram showing frequency characteristics of a general dynamic speaker. Division is performed by defining a frequency band lower than the lowest resonance frequency f0 of the speaker in FIG. 7 as a low range (Lo), a frequency band from f0 to less than 6 kHz, for example, as a mid range (Mid), and a frequency band of 6 kHz or more as a high range (Hi). It is to be noted that these definitions are exemplary, and the ranges of the respective bands may be changed in accordance with speaker characteristics.

In the selector 16, in accordance with a result of determining the orientation of the device with respect to the direction of gravitational force sensed by the orientation sensor 7 performed in steps A4 to A10 of FIG. 5, the three signals of the mid/high signal (L_Mid+Hi) of the left channel, the mid/high signal (R_Mid+Hi) of the right channel, and the low signal (L+R_Lo) are assigned to the respective speakers 4, 5 and 6 in accordance with states A to D of FIG. 3 and FIG. 4, by the controller 8.

For example, in a case where the determination result is state D (see FIG. 3), for sound output from the respective speakers 4, 5 and 6, as shown in FIG. 4, the selector 16 assigns a low range signal (L+R_Lo) as a woofer to the first speaker 4, a mid/high range signal (L_Mid+Hi) of the left channel to the second speaker 5, and a mid/high range signal (R_Mid+Hi) of the right channel to the third speaker 6 (see FIG. 6).

The respective signals of the low range signal (L+R_Lo), the mid/high range signal (L_Mid+Hi) of the left channel and the mid/high range signal (R_Mid+Hi) of the right channel assigned to the respective speakers 4, 5 and 6, are converted from digital signals to analog signals by the corresponding D/A converters 17, 18 and 19, are amplified by the corresponding speaker amplifiers 20, 21 and 22, and are outputted as sound information from the respective speakers 4, 5 and 6.

Change is performed with regard to the direction of an image displayed in the display unit 2 together with orientation of the device (states A to D in FIG. 3), matching speaker output settings of the respective states A to D in steps A7 to A10 of FIG. 5. For example, in state D, an image is displayed in the display unit 2 such that the side on which the speakers 5 and 6 are mounted is to the bottom, as shown in FIG. 3.

It is to be noted that in the description of the first exemplary embodiment, a description of operations when a video is previewed was given as an example, but similar control can also be performed in a case of executing a function of outputting a screen display and sound information such as music as in a music replay or a game.

According to the first exemplary embodiment, irrespective of the orientation of the device, by outputting a mid/high range signal (R_Mid+Hi) of the right channel from a speaker disposed on the user's right side, a mid/high range signal (L_Mid+Hi) of the left channel from a speaker on the left side, and a low range signal (L+R_Lo) from a remaining speaker, preferable stereo surround effects can be obtained matching the screen display with a rich base range even with a miniature speaker.

### Second Exemplary Embodiment

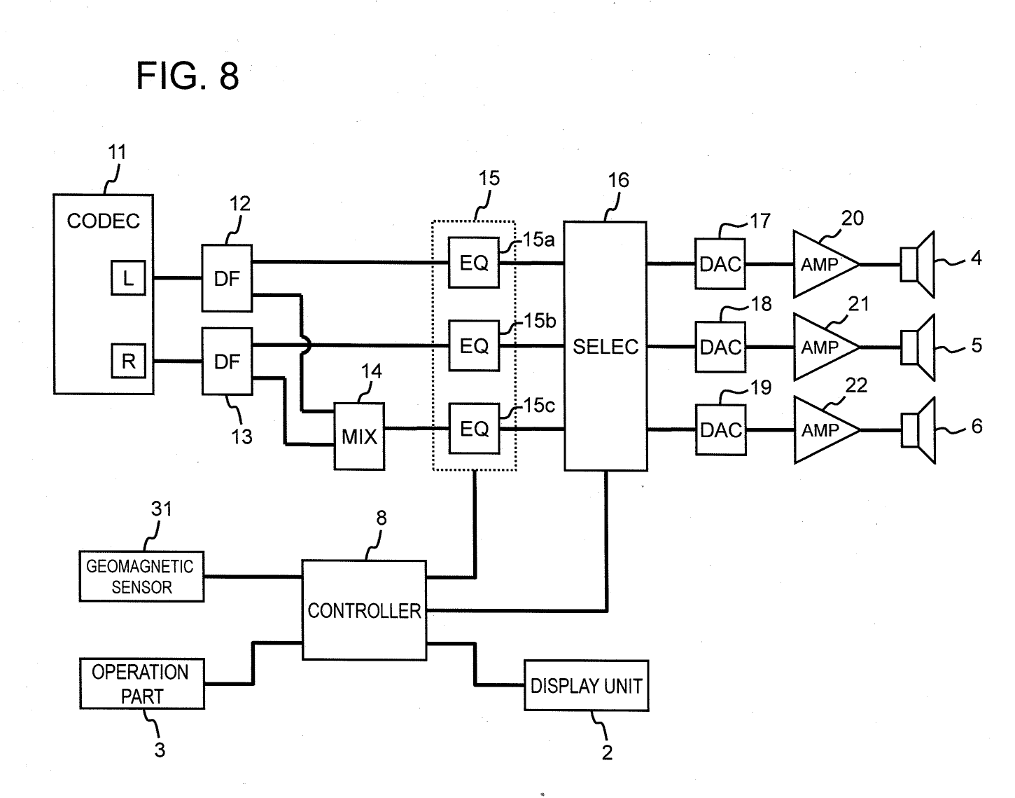

A description is given using the drawings concerning the information terminal device according to a second exemplary embodiment of the present disclosure. FIG. 8 is a block diagram schematically showing a circuit configuration of the information terminal device according to the second exemplary embodiment of the disclosure.

The second exemplary embodiment is a modified example of the first exemplary embodiment, where respective signals of a mid/high range signal (R_Mid+Hi) of a right channel from a digital filter 12, a mid/high range signal (L_Mid+Hi) of a left channel from a digital filter 13, and a low range signal (L+R_Lo) from a mixer 14, are inputted to a selector 16 through an equalizer 15. In the second exemplary embodiment, a geomagnetic sensor 31 is used instead of an orientation sensor (7 in FIG. 2) as in the first exemplary embodiment.

The equalizer 15 is a functional unit that can perform correction and level adjustment of a frequency characteristic of a received signal, and can perform output. The equalizer 15 is a functional unit that can perform individual level adjustment and correction of frequency characteristics of a received signal, through control by a controller 8. The equalizer 15 may be configured by software. The equalizer 15 has equalizer parts 15a, 15b and 15c.

The equalizer part 15a is a functional unit that can perform level adjustment and correction of frequency characteristics of a mid/high range signal (R_Mid+Hi) of the right channel from the digital filter 12, by control of the controller 8. The equalizer part 15b is a functional unit that can perform level adjustment and correction of frequency characteristics of a mid/high range signal (L_Mid+Hi) of the left channel from the digital filter 13, by control of the controller 8. The equalizer 15c is a functional unit that can perform level adjustment and correction of frequency characteristics of a low range signal (L+R_Lo) from the mixer 14, by control of the controller 8.

The geomagnetic sensor 31 is a functional unit that senses orientation (bearing, direction, inclination) of the information terminal device 1 that is being held by a user, using geomagnetism. The geomagnetic sensor 31 may be mounted inside the information terminal device 1. The geomagnetic sensor 31 outputs a signal related to the sensed orientation of the information terminal device 1 to the controller 8.

It is to be noted that the controller 8 can individually control the respective equalizer parts 15a, 15b and 15c of the equalizer 15. Otherwise, the configuration is similar to the first exemplary embodiment.

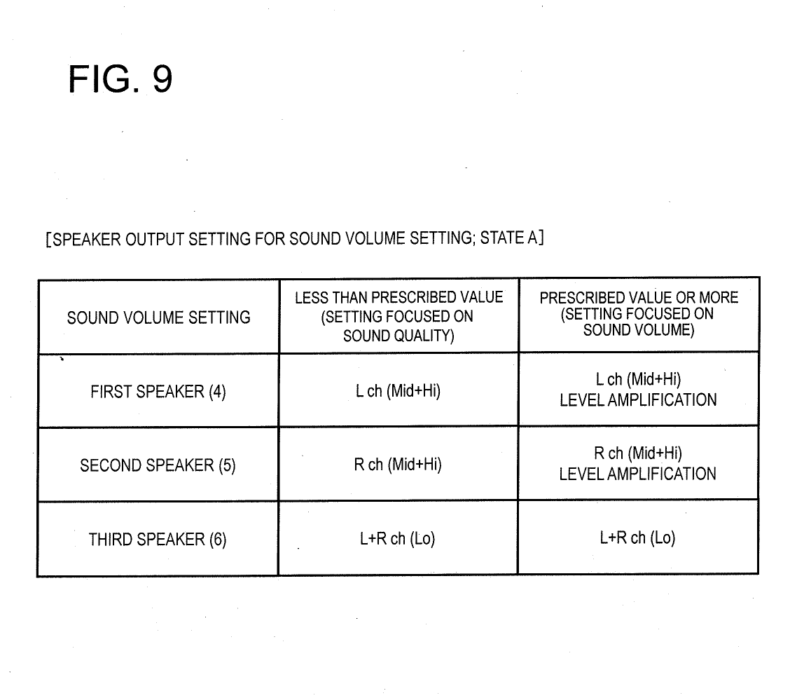

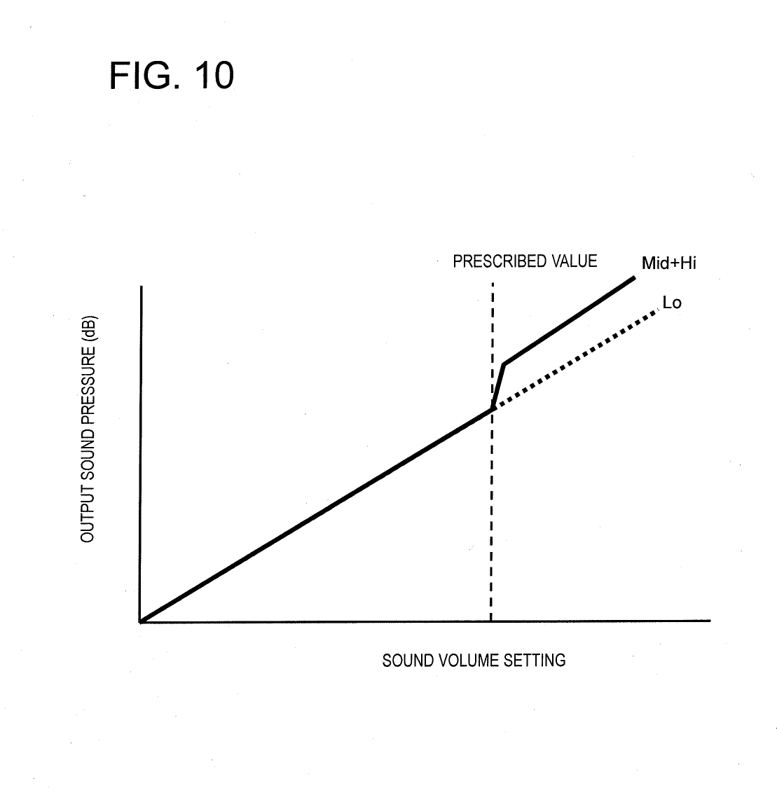

Next, a description is given using the drawings concerning operations of the information terminal device according to the second exemplary embodiment of the present disclosure. FIG. 9 is a table showing speaker output settings with regard to sound volume settings in state A when the orientation of a device is changed with respect to the direction of gravitational force when viewing a video or the like with the information terminal device according to the second exemplary embodiment of the disclosure. FIG. 10 is a diagram showing low range and mid/wide range output sound pressure for a speaker with regard to sound volume settings in state A when the orientation of the device is changed with respect to the direction of gravitational force when viewing a video or the like with the information terminal device according to the second exemplary embodiment of the disclosure.

For example, in a case where the orientation of the information terminal device 1 is that of state A (see FIG. 3), when the sound volume setting is less than a prescribed value (or the setting is focused on sound quality), by control of the controller 8 the selector 16 is set so that a mid/high range stereo signal (L ch (Mid+Hi)) of the left channel is outputted from a first speaker 4, a mid/high range stereo signal (R ch (Mid+Hi)) of the right channel is outputted from a second speaker 5, and a low range monaural signal (L+R ch (Lo)) synthesizing low range stereo signals of the left channel and the right channel is outputted from a third speaker 6. At this time, the equalizer 15 is controlled by the controller 8 so that level adjustment and correction of frequency characteristics of an inputted signal are not performed (see FIG. 10: values less than a prescribed value).

In a case of state A (see FIG. 3), when the sound volume setting is a prescribed value or more (or the setting is focused on sound volume), by control of the controller 8 the selector 16 is set so that a mid/high range stereo signal (L ch (Mid+Hi)) of the left channel is outputted from the first speaker 4, a mid/high range stereo signal (R ch (Mid+Hi)) of the right channel is outputted from a second speaker 5, and a low range monaural signal (L+R ch (Lo)) synthesizing low range stereo signals of the left channel and the right channel is outputted from the third speaker 6. At this time, the equalizer 15 is controlled by the controller 8 so that the level of the inputted mid/high range stereo signals (L ch (Mid+Hi)) and (R ch (Mid+Hi)) is amplified (amplified to close to the maximum input level of the speaker), and level adjustment and correction of frequency characteristics of the low range monaural signal (L+R ch (Lo)) are not performed (see FIG. 10: values of a prescribed value or more).

It is to be noted that in states B to D (see FIG. 3), similar to the case of state A, the selector 16 and the equalizer 15 are controlled by the controller 8.

FIG. 10 indicates that where the sound volume setting is less than a prescribed value (low or mid setting), output sound pressure changes linearly, and where the sound volume setting is a prescribed value or more (high setting), the sound volume is amplified above a straight line and outputted. In FIG. 10, the output signal of each speaker is switched in accordance with sound volume setting, but definitions are also possible with a sound quality setting, rather than a sound volume setting.

According to the second exemplary embodiment, an effect similar to the first exemplary embodiment is realized; in addition, adjustment focusing on sound volume or sound quality is possible in accordance with a sound volume setting or an effect setting (sound quality focused setting, sound volume focused setting) of the speakers 4, 5 and 6, and furthermore a preferable stereo surround effect is obtained. In particular, when the sound volume setting is a prescribed value or more, it is possible to listen to voice and music with sound quality focusing on sound volume emphasizing the level of mid/high range stereo signals.

### Third Exemplary Embodiment

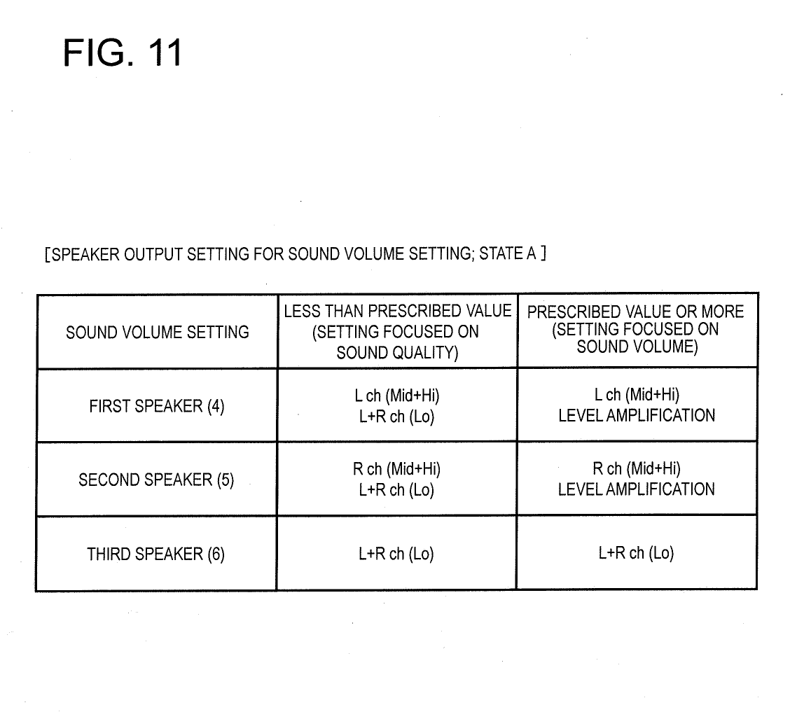

A description is given using the drawings concerning the information terminal device according to a third exemplary embodiment of the present disclosure. FIG. 11 is a table showing speaker output settings with regard to sound volume settings in state A when the orientation of a device is changed with respect to the direction of gravitational force when viewing a video or the like with the information terminal device according to the third exemplary embodiment of the disclosure.

The third exemplary embodiment is an example in which the second exemplary embodiment is modified; when the sound volume setting is less than a prescribed value (or the setting is focused on sound quality), a low range monaural signal (L+R ch (Lo)) is outputted by all speakers 4, 5 and 6. That is, when the sound volume setting is less than a prescribed value, a selector (corresponding to 16 in FIG. 8) can be controlled so that a low range monaural signal is outputted from speakers to the left and right with respect to a user. Otherwise, the configuration and operations are similar to the second exemplary embodiment.

For example, in a case where the orientation of the information terminal device (corresponding to 1 in FIG. 8) is in state A (see FIG. 3), when the sound volume setting is less than a prescribed value (or the setting is focused on sound quality), by control of a controller (corresponding to 8 in FIG. 8) the selector (corresponding to 16 in FIG. 8) is set as follows. A mid/high range stereo signal (L ch (Mid+Hi)) and a low range monaural signal (L+R ch (Lo)) of the left channel are outputted from a first speaker (corresponding to 4 in FIG. 8) at the same time. A mid/high range stereo signal (R ch (Mid+Hi)) of the right channel and a low range monaural signal (L+R ch (Lo)) are outputted at the same time from a second speaker (corresponding to 5 in FIG. 8). In addition, a low range monaural signal (L+R ch (Lo)) synthesizing low range stereo signals of the left channel and the right channel is outputted from the third speaker (corresponding to 6 in FIG. 8). At this time, an equalizer (corresponding to 15 in FIG. 8) is controlled by the controller (corresponding to 8 in FIG. 8) so that level adjustment and correction of frequency characteristics of an inputted signal are not performed (see FIG. 10, values less than a prescribed value).

In a case of state A (see FIG. 3), when the sound volume setting is a prescribed value or more (or the setting is focused on sound volume), by control of the controller (corresponding to 8 in FIG. 8), the selector 16 is set so that a mid/high range stereo signal (L ch (Mid+Hi)) of the left channel is outputted from the first speaker 4, a mid/high range stereo signal (R ch (Mid+Hi)) of the right channel is outputted from the second speaker 5, and a low range monaural signal (L+R ch (Lo)) synthesizing low range stereo signals of the left channel and the right channel is outputted from the third speaker 6. That is, the low range monaural signal (L+R ch (Lo)) is not outputted from the first speaker 4 and the second speaker 5. At this time, the equalizer 15 is controlled by the controller 8 so that the level of the inputted mid/high range stereo signals (L ch (Mid+Hi)) and (R ch (Mid+Hi)) is amplified (amplified to close to the maximum input level of the speaker), and level adjustment and correction of frequency characteristics of the low range monaural signal (L+R ch (Lo)) are not performed (see FIG. 10: values of a prescribed value or more).

It is to be noted that in states B to D (see FIG. 3), similar to the case of state A, the selector 16 and the equalizer 15 are controlled by the controller 8.

According to the third exemplary embodiment, an effect similar to the second exemplary embodiment is realized; in addition, in a case where the sound volume setting is less than a prescribed value, by outputting a low range monaural signal from speakers to the left and right with respect to the user, it is possible to output with a focus on rich sound quality for low tones. In a case where the sound volume setting is a prescribed value or more, by outputting only mid/high range stereo signals obtained by performing band division of signals outputted from speakers to the left and right of the user, by a digital filter (corresponding to 12 and 13 in FIG. 8), it is possible to output with a focus on sound volume.

### Fourth Exemplary Embodiment

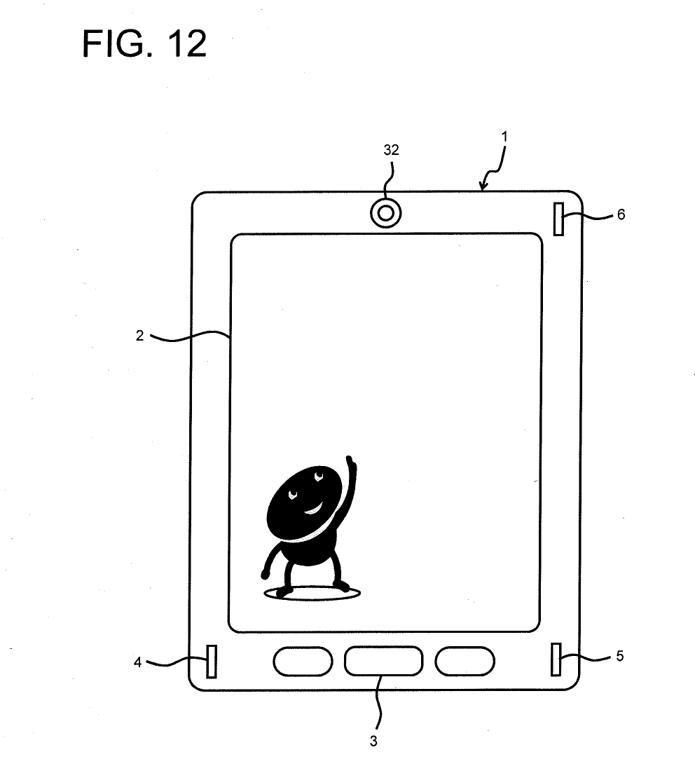

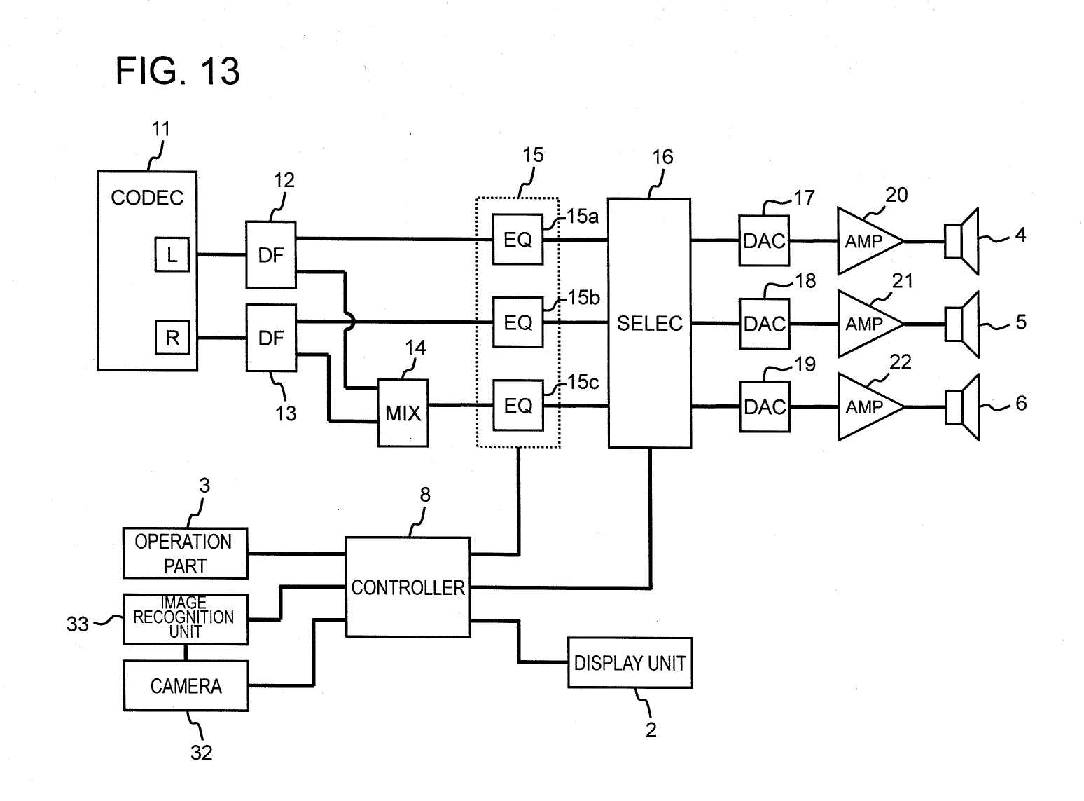

A description is given using the drawings concerning the information terminal device according to a fourth exemplary embodiment of the present disclosure. FIG. 12 is an outline view schematically showing the configuration of an external view of the information terminal device according to the fourth exemplary embodiment of the disclosure. FIG. 13 is a block diagram schematically showing a circuit configuration of the information terminal device according to the fourth exemplary embodiment of the disclosure.

The fourth exemplary embodiment is an exemplary modification of the first to third exemplary embodiments, in which a camera 32 and an image recognition unit 33 are used instead of an orientation sensor or a geomagnetic sensor 31 to sense the orientation of the information terminal device 1 that is held by a user.

The camera 32 is a functional unit that takes video or still images. The camera 32 is mounted at a prescribed position (above a display unit 2 in FIG. 12) of a peripheral part of the display unit 2 on the face of the display unit 2 of the information terminal device 1. Operations of the camera 32 are controlled by a controller 8. A signal related to a video or a still image taken by the camera 32 is outputted to the image recognition unit 33.

The image recognition unit 33 is a functional unit that recognizes the orientation of the face of the user by performing image analysis of the signal related to the image taken by the camera 32. The image recognition unit 33 is mounted inside the information terminal device 1. The image recognition unit 33 is controlled by the controller 8. The image recognition unit 33 outputs recognized information related to the orientation of the face of the user to the controller 8. The information related to the orientation of the face of the user is used in adjustment of orientation of the screen in the display unit 2 and of output of speakers 4, 5 and 6, by the controller 8.

Otherwise, the configuration and operations are similar to the first to third exemplary embodiments.

According to the fourth exemplary embodiment, an effect similar to the first to third exemplary embodiments is realized, and in addition, since there is no dependency on geomagnetism, it is possible to optimize the screen orientation and speaker output even in a case where the user is viewing a video while holding the terminal in the state of lying down.

### Fifth Exemplary Embodiment

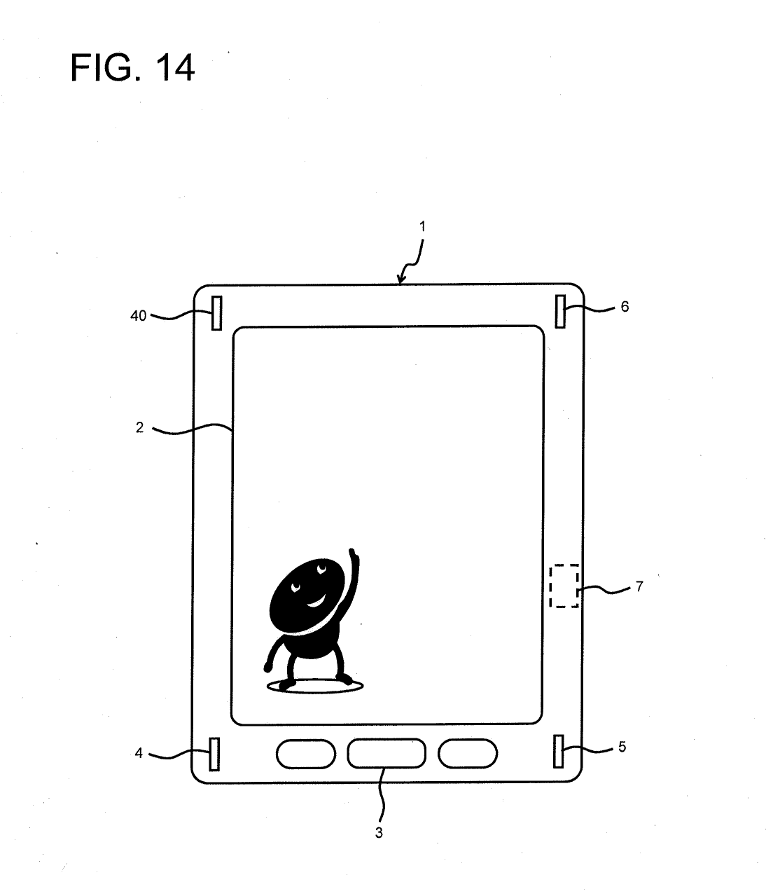

A description is given using the drawings concerning the information terminal device according to a fifth exemplary embodiment of the present disclosure. FIG. 14 is an outline view schematically showing the configuration of an external view of the information terminal device according to the fifth exemplary embodiment of the disclosure.

The fifth exemplary embodiment is an exemplary modification of the first to fourth exemplary embodiments, in which there are four speakers 4, 5, 6 and 40, mounted at the four corners of the rectangular shaped face of a display unit 2 side. Otherwise, the configuration is similar to the first to fourth exemplary embodiments. In the fifth exemplary embodiment, it is possible to perform control such that mid/high range stereo signal of a right channel is outputted from one speaker disposed at the top right or the bottom right with respect to the user, a mid/high range stereo signal of a left channel is outputted from one speaker disposed at the top left or the bottom left with respect to the user, and a low range monaural signal is outputted from the two remaining speakers. For example, when the orientation of the information terminal device 1 is in a state as in FIG. 14, it is possible to output a mid/high range stereo signal of the right channel from the speaker 6, a mid/high range stereo signal of the left channel from the speaker 40, and a low range monaural signal from the speakers 4 and 5.

According to the fifth exemplary embodiment, an effect similar to the first to fourth exemplary embodiments is realized.

### Sixth Exemplary Embodiment

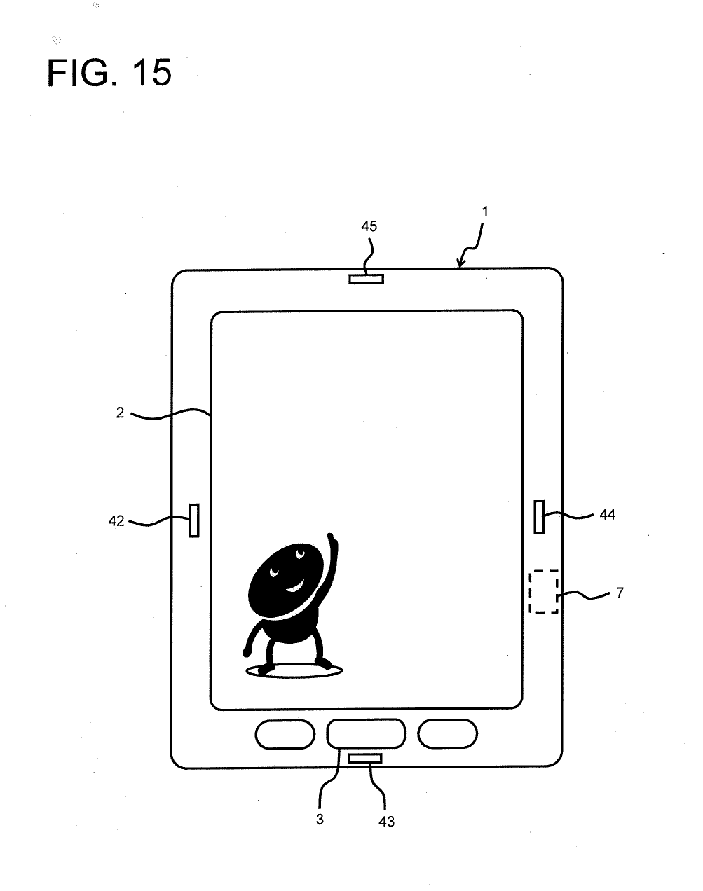

A description is given using the drawings concerning the information terminal device according to a sixth exemplary embodiment of the disclosure. FIG. 15 is an outline view schematically showing the configuration of an external view of the information terminal device according to the sixth exemplary embodiment of the disclosure.

The sixth exemplary embodiment is an exemplary modification of the first to fourth exemplary embodiments, with four speakers 42, 43, 44 and 45 mounted near the center of the four sides of the rectangular shaped face of a display unit 2 side. Otherwise, the configuration is similar to the first to fourth exemplary embodiments. In the sixth exemplary embodiment, it is possible to perform control such that a mid/high range stereo signal of a right channel is outputted from a speaker disposed at the right with respect to a user, a mid/high range stereo signal of a left channel is outputted from a speaker disposed at the left with respect to the user, and a low range monaural signal is outputted from the two remaining speakers. For example, when the orientation of the information terminal device 1 is in a state as in FIG. 15, it is possible to output a mid/high range stereo signal of the right channel from the speaker 44, a mid/high range stereo signal of the left channel from the speaker 42, and a low range monaural signal from the speakers 43 and 45.

According to the sixth exemplary embodiment an effect similar to the first to fourth exemplary embodiments is realized.

### Seventh Exemplary Embodiment

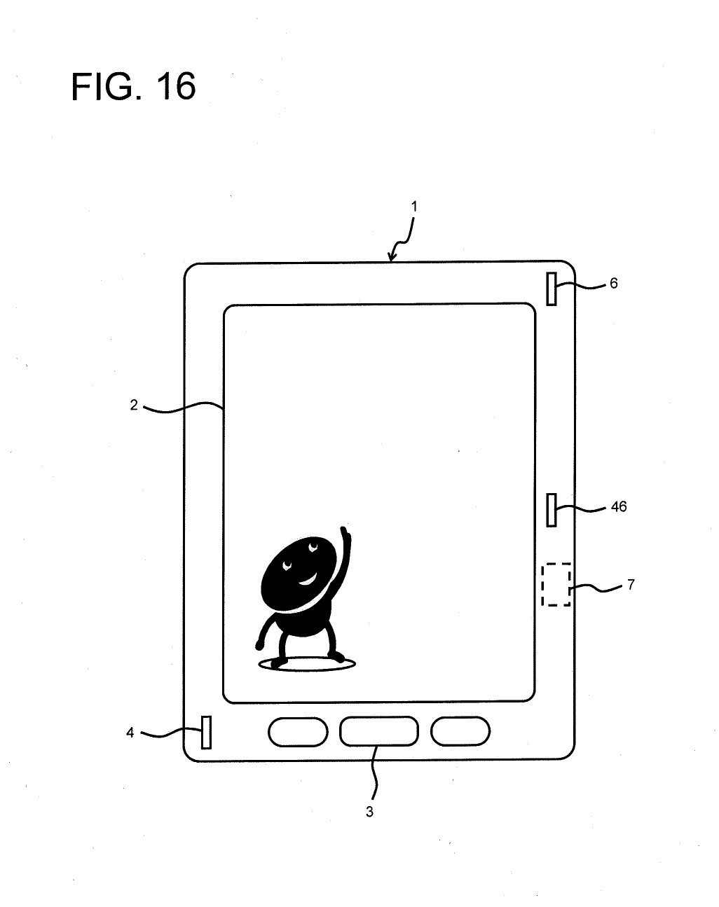

A description is given using the drawings concerning operations of the information terminal device according to a seventh exemplary embodiment of the present disclosure. FIG. 16 is an outline view schematically showing the configuration of an external view of the information terminal device according to the seventh exemplary embodiment of the disclosure.

The seventh exemplary embodiment is an exemplary modification of the first to fourth exemplary embodiments, with three speakers 4, 6 and 46, two of which are mounted on opposing corners of the rectangular shaped face of a display unit 2 side, and one of which is mounted at any position on the face of the display unit 2 side. Otherwise, the configuration is similar to the first to fourth exemplary embodiments. In the seventh exemplary embodiment, it is possible to perform control such that a mid/high range stereo signal of a right channel is outputted from a speaker (excluding speaker 46) disposed on the right side of a user, a mid/high range stereo signal of a left channel is outputted from a speaker (excluding speaker 46) disposed on the left side of the user, and a low range monaural signal is outputted from the one remaining speaker 46. For example, where the orientation of the information terminal device 1 is in a state as in FIG. 16, it is possible to output a mid/high range stereo signal of the right channel from the speaker 6, a mid/high range stereo signal of the left channel from the speaker 4, and a low range monaural signal from the speaker 46.

According to the seventh exemplary embodiment, an effect similar to the first to fourth exemplary embodiments is realized; the mounting position of the speaker 46 need not be particularly specified, and, it is possible to use as a preferable woofer, by mounting a speaker of size larger than speakers 4 and 6.

It is to be noted that the reference symbols attached to the drawings of the present application are provided solely as an aid to understanding and are not intended to limit the invention to modes shown in the drawings.

Modifications and adjustments of embodiments and examples are possible within the bounds of the entire disclosure (including the scope of the claims) of the present invention, and also based on fundamental technological concepts thereof. Furthermore, a wide variety of combinations and selections of various disclosed elements (including respective elements of the respective claims, respective elements of the respective exemplary embodiments and examples, and respective elements of the respective drawings) is possible within the scope of the claims of the present invention. That is, the present invention clearly includes every type of transformation and modification that a person skilled in the art can realize according to the entire disclosure including the scope of the claims and drawings, and to technological concepts thereof.

### APPENDIX

In a first aspect of the present disclosure, an information terminal device comprises: a display unit displaying an image; at least 3 speakers disposed at prescribed positions on a periphery of the display unit and outputting sound information; a first filter dividing a stereo signal of a left channel, among the sound information, into two signals: a low range stereo signal having a frequency less than a prescribed frequency and a mid/high range stereo signal having the prescribed frequency or more; a second filter dividing a stereo signal of a right channel, among the sound information, into two signals: a low range stereo signal having a frequency less than the prescribed frequency and a mid/high range stereo signal having the prescribed frequency or more; a mixer generating a low range monaural signal synthesizing the low range stereo signal of the left channel from the first filter and the low range stereo signal of the right channel from the second filter; a selector assigning the mid/high range stereo signal of the left channel from the first filter, the mid/high range stereo signal of the right channel from the second filter, and the low range monaural signal from the mixer, to the at least three speakers; an orientation sensor sensing orientation of the information terminal device held by a user; and a controller controlling the selector so as to switch orientation of the image in the display unit is switched and switch a signal inputted to the speakers, in accordance with the orientation of the information terminal device sensed by the orientation sensor; wherein the controller controls the selector so that, among the at least 3 speakers, the mid/high range stereo signal of the right channel is inputted to at least one speaker on the right side with respect to the user, the mid/high range stereo signal of the left channel is inputted to at least one speaker on the left side with respect to the user, and the low range monaural signal is inputted to another speaker.

The information terminal device of the disclosure preferably includes an equalizer changing, amplification amount of the mid/high range stereo signal of the left channel from the first filter, the mid/high range stereo signal of the right channel from the second filter, and the low range monaural signal from the mixer, in accordance with control by the controller, and outputting to the selector.

In the information terminal device of the disclosure, when sound volume setting is less than a prescribed value or setting focused on sound quality, the controller preferably controls so as not to amplify the mid/high range stereo signal of the left channel from the first filter, the mid/high range stereo signal of the right channel from the second filter, and the low range monaural signal from the mixer, and when the sound volume setting is a prescribed value or more, or setting focused on sound volume, controls so as to amplify the mid/high range stereo signal of the left channel from the first filter and the mid/high range stereo signal of the right channel from the second filter, and not to amplify the low range monaural signal from the mixer.

In the information terminal device of the disclosure, the controller preferably controls the selector so that, with regard to the at least 3 speakers: the low range monaural signal and the mid/high range stereo signal of the right channel are inputted to at least one right-side speaker with respect to the user, the low range monaural signal and the mid/high range stereo signal of the left channel are inputted to at least one left-side speaker with respect to the user, and the low range monaural signal is inputted to the other speaker.

In the information terminal device of the disclosure, the orientation sensor is preferably a geomagnetic sensor that senses orientation of the information terminal device that is held by a user, using geomagnetism.

In the information terminal device of the disclosure, the orientation sensor preferably includes a camera disposed on a face of the display unit side and taking video or a still image; and an image recognition unit recognizing the orientation of a user's face by performing image analysis of a signal related to an image taken by the camera.

In the information terminal device of the disclosure, the at least 3 speakers are preferably disposed in at least 3 among the four corners of a rectangular shaped face of the display unit side.

In the information terminal device of the disclosure, the at least 3 speakers are preferably disposed near the center of at least 3 sides among the four sides of a rectangular shaped face of the display unit side.

In the information terminal device of the disclosure, the at least speakers are preferably disposed in two opposing corners of a rectangular shaped face of the display unit side and at any one location on a face of the display unit side.

In a second aspect of the disclosure, a sound control method controls sound using an information terminal device, comprising: a display unit displaying an image; at least 3 speakers disposed at prescribed positions on a periphery of the display unit and outputting sound information; a first filter dividing a stereo signal of a left channel, among the sound information, into two signals: a low range stereo signal having a frequency less than a prescribed frequency and a mid/high range stereo signal having the prescribed frequency or more; a second filter dividing a stereo signal of a right channel, among the sound information, into two signals: a low range stereo signal having a frequency less than the prescribed frequency and a mid/high range stereo signal having the prescribed frequency or more; a mixer generating a low range monaural signal synthesizing the low range stereo signal of the left channel from the first filter and the low range stereo signal of the right channel from the second filter; a selector assigning the mid/high range stereo signal of the left channel from the first filter, the mid/high range stereo signal of the right channel from the second filter, and the low range monaural signal from the mixer, to the at least three speakers; an orientation sensor sensing orientation of the information terminal device held by a user; and a controller controlling the display unit and the selector; wherein the method comprises controlling the selector, by the controller, so that orientation of the image in the display unit is switched in accordance with the orientation of the information terminal device sensed by the orientation sensor, and also, among the at least 3 speakers, the mid/high range stereo signal of the right channel is inputted to at least one speaker on the right side with respect to the user, the mid/high range stereo signal of the left channel is inputted to at least one speaker on the left side with respect to the user, and the low range monaural signal is inputted to another speaker.

In a third aspect of the disclosure, a program controls sound using an information terminal device comprising: a display unit displaying an image; at least 3 speakers disposed at prescribed positions on a periphery of the display unit and outputting sound information; a first filter dividing a stereo signal of a left channel, among the sound information, into two signals: a low range stereo signal having a frequency less than a prescribed frequency and a mid/high range stereo signal having the prescribed frequency or more; a second filter dividing a stereo signal of a right channel, among the sound information, into two signals: a low range stereo signal having a frequency less than the prescribed frequency and a mid/high range stereo signal having the prescribed frequency or more; a mixer generating a low range monaural signal synthesizing the low range stereo signal of the left channel from the first filter and the low range stereo signal of the right channel from the second filter; a selector assigning the mid/high range stereo signal of the left channel from the first filter, the mid/high range stereo signal of the right channel from the second filter, and the low range monaural signal from the mixer, to the at least three speakers; an orientation sensor sensing orientation of the information terminal device held by a user; and a controller controlling the display unit and the selector; wherein the program executes control of the selector, by the controller, so that orientation of the image in the display unit is switched in accordance with the orientation of the information terminal device sensed by the orientation sensor, and also, among the at least 3 speakers, the mid/high range stereo signal of the right channel is inputted to at least one speaker on the right side with respect to the user, the mid/high range stereo signal of the left channel is inputted to at least one speaker on the left side with respect to the user, and the low range monaural signal is inputted to another speaker.

What is claimed is:

1. An information terminal device, comprising:
a display unit displaying an image;
at least 3 speakers disposed at prescribed positions on a periphery of said display unit and outputting sound information;
a first filter dividing a stereo signal of a left channel, among said sound information, into two signals: a low range stereo signal having a frequency less than a prescribed frequency and a mid/high range stereo signal having said prescribed frequency or more;
a second filter dividing a stereo signal of a right channel, among said sound information, into two signals: a low range stereo signal having a frequency less than said prescribed frequency and a mid/high range stereo signal having said prescribed frequency or more; al signal synthe
a mixer generating a low range monaursizing said low range stereo signal of said left channel from said first filter and said low range stereo signal of said right channel from said second filter;
a selector assigning said mid/high range stereo signal of said left channel from said first filter, said mid/high range stereo signal of said right channel from said second filter, and said low range monaural signal from said mixer, to said at least three speakers;
an orientation sensor sensing orientation of said information terminal device held by a user; and
a controller controlling said selector so as to switch orientation of said image in said display unit is switched and switch a signal inputted to said speakers, in accordance with the orientation of said information terminal device sensed by said orientation sensor; wherein
said controller controls said selector so that, among said at least 3 speakers, said mid/high range stereo signal of said right channel is inputted to at least one speaker on the right side with respect to the user, said mid/high range stereo signal of said left channel is inputted to at least one speaker on the left side with respect to the user, and said low range monaural signal is inputted to another speaker.

2. The information terminal device according to claim 1, comprising: an equalizer changing, amplification amount of said mid/high range stereo signal of said left channel from said first filter, said, mid/high range stereo signal of said right channel from said second filter, and said low range monaural signal from said mixer, in accordance with control by said controller, and outputting to said selector.

3. The information terminal device according to claim 2, wherein said controller:
when sound volume setting is less than a prescribed value or setting focused on sound quality, controls so as not to amplify said mid/high range stereo signal of said left channel from said first filter, said mid/high range stereo signal of said right channel from said second filter, and said low range monaural signal from said mixer, and
when said sound volume setting is a prescribed value or more, or setting focused on sound volume, controls so as to amplify said mid/high range stereo signal of said left channel from said first filter and said mid/high range stereo signal of said right channel from said second filter, and not to amplify said low range monaural signal from said mixer.

4. The information terminal device according to claim 1, wherein said controller controls said selector so that, with regard to said at least 3 speakers:
said mid/high range stereo signal of said right channel and said low range monaural signal are inputted to at least one right-side speaker with respect to the user,
said mid/high range stereo signal of said left channel and said low range monaural signal are inputted to at least one left-side speaker with respect to the user, and
said low range monaural signal is inputted to the other speaker.

5. The information terminal device according to claim 1, wherein said orientation sensor is a geomagnetic sensor that senses orientation of said information terminal device that is held by a user, using geomagnetism.

6. The information terminal device according to claim 1, wherein said orientation sensor comprises:
a camera disposed on a face of said display unit side and taking video or a still image; and
an image recognition unit recognizing the orientation of a user's face by performing image analysis of a signal related to an image taken by said camera.

7. The information terminal device according to claim 1, wherein said at least 3 speakers are disposed in at least 3 of the four corners of a rectangular shaped face of said display unit side.

8. The information terminal device according to claim 1, wherein said at least 3 speakers are disposed near the center of at least 3 sides among the four sides of a rectangular shaped face of said display unit side.

9. A sound control method that controls sound using an information terminal device comprising:
a display unit displaying an image;
at least 3 speakers disposed at prescribed positions on a periphery of said display unit and outputting sound information;
a first filter dividing a stereo signal of a left channel, among said sound information, into two signals: a low range stereo signal having a frequency less than a prescribed frequency and a mid/high range stereo signal having said prescribed frequency or more;
a second filter dividing a stereo signal of a right channel, among said sound information, into two signals: a low range stereo signal having a frequency less than said prescribed frequency and a mid/high range stereo signal having said prescribed frequency or more;
a mixer generating a low range monaural signal synthesizing said low range stereo signal of said left channel from said first filter and said low range stereo signal of said right channel from said second filter;
a selector assigning said mid/high range stereo signal of said left channel from said first filter, said mid/high range stereo signal of said right channel from said second filter, and said low range monaural signal from said mixer, to said at least three speakers;
an orientation sensor sensing orientation of said information terminal device held by a user; and
a controller controlling said display unit and said selector; wherein
said method comprises controlling said selector, by said controller, so that orientation of said image in said display unit is switched in accordance with the orientation of said information terminal device sensed by said orientation sensor, and also, among said at least 3 speakers, said mid/high range stereo signal of said right channel is inputted to at least one speaker on the right side with respect to the user, said mid/high range stereo signal of said left channel is inputted to at least one speaker on the left side with respect to the user, and said low range monaural signal is inputted to another speaker.

10. A program that controls sound using an information terminal device comprising:
a display unit displaying an image;
at least 3 speakers disposed at prescribed positions on a periphery of said display unit and outputting sound information;
a first filter dividing a stereo signal of a left channel, among said sound information, into two signals: a low range stereo signal having a frequency less than a prescribed frequency and a mid/high range stereo signal having said prescribed frequency or more;
a second filter dividing a stereo signal of a right channel, among said sound information, into two signals: a low range stereo signal having a frequency less than said prescribed frequency and a mid/high range stereo signal having said prescribed frequency or more;
a mixer generating a low range monaural signal synthesizing said low range stereo signal of said left channel from said first filter and said low range stereo signal of said right channel from said second filter;
a selector assigning said mid/high range stereo signal of said left channel from said first filter, said mid/high range stereo signal of said right channel from said second filter, and said low range monaural signal from said mixer, to said at least three speakers;
an orientation sensor sensing orientation of said information terminal device held by a user; and
a controller controlling said display unit and said selector; wherein
said program executes control of said selector, by said controller, so that orientation of said image in said display unit is switched in accordance with the orientation of said information terminal device sensed by said orientation sensor, and also, among said at least 3 speakers, said mid/high range stereo signal of said right channel is inputted to at least one speaker on the right side with respect to the user, said mid/high range stereo signal of said left channel is inputted to at least one speaker on the left side with respect to the user, and said low range monaural signal is inputted to another speaker.
